(19) United States
(12) Patent Application Publication
(10) Pub. No.: US 2015/0071554 A1
(43) Pub. Date: Mar. 12, 2015

(54) ELECTRONIC DEVICE, EQUATION COMPUTING SYSTEM AND METHOD

(71) Applicant: FIH (Hong Kong) Limited, Kowloon (HK)

(72) Inventor: CHIEN-WEI CHEN, New Taipei (TW)

(21) Appl. No.: 14/477,134

(22) Filed: Sep. 4, 2014

(30) Foreign Application Priority Data
Sep. 6, 2013 (CN) 2013104037937

(51) Int. Cl. G06K 9/48

(52) U.S. Cl. CPC G06K 9/481
USPC 382/203

(57) ABSTRACT

An electronic device and an equation computing method are provided. The electronic device receives parameters and conversion equations for converting the input parameters to vectors input by a user, and then converts the parameters input by the user to vectors according to the equation. The electronic device further obtains a non-linear equation according to the vectors, and executes a curve surface fitting process to obtain a fitting curve surface according to the non-linear equation. At last, the electronic device obtains a fitting equation according to the fitting curve surface.

### CROSS-REFERENCE TO RELATED APPLICATIONS

This application claims priority to Chinese Patent Application No. 201310403793.7 filed on September 6, the contents of which are incorporated by reference herein.

### FIELD

The subject matter herein generally relates to equation computing, and particularly to a curved surface fitting equation computing system and a method thereof.

### BACKGROUND

Curved surface fitting equations are used to construct curve surfaces, and the curved surface fitting equation is widely used in image processing.

### BRIEF DESCRIPTION OF THE DRAWINGS

Implementations of the present technology will now be described, by way of example only, with reference to the attached figures.

FIG. 1 is a block diagram illustrating an example embodiment of an electronic device running an equation computing system.

FIG. 2 is a flowchart of an example embodiment of an equation computing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout disclosure will now be presented. The term “module” refers to logic embodied in computing or firmware, or to a collection of software instruction, written in a programming language, such as Java, C, or assembly. One or more software instruction in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “coupled” is defined as connected, whether directly or indirectly through intervening components, and is not necessarily limited to physical connections. The connection can be such that the objects are permanently connected or releasably connected. The term “comprising” means “including, but not necessarily limited to”, it specifically indicates open-ended inclusion or membership in a so-described combination, group, series and the like.

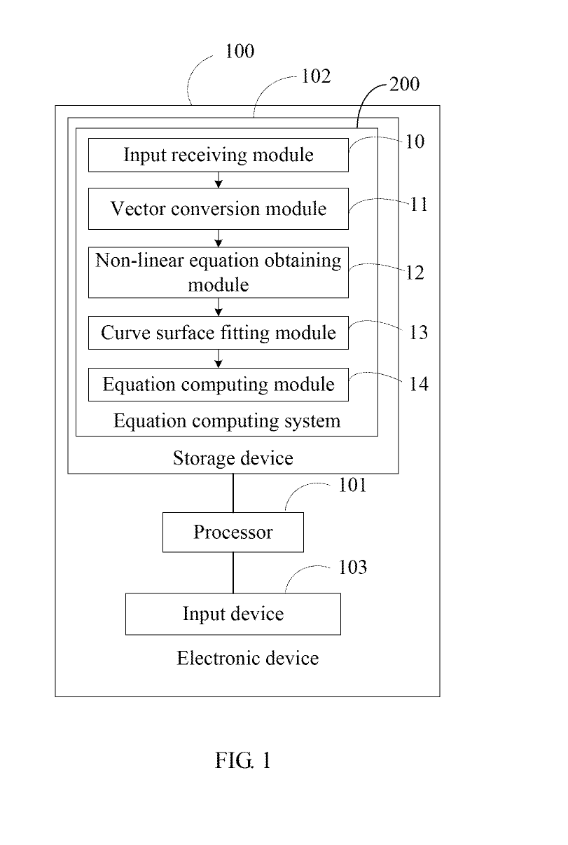

FIG. 1 illustrates a block diagram of an electronic device 100 running an equation computing system 200. The electronic device 100 can compute a curve surface fitting equation via curve surface fitting, according to parameters input by user.

The electronic device 100 can include a processor 101, a storage device 102, and an input device 103. The processor 101 is coupled to the storage device 102 and the input device 103. In one embodiment, the processor 101 can be a central processing unit (CPU), a microprocessor, or other data processor chips that perform functions of the electronic device 100. The storage device 102 can be an internal storage system, such as a flash memory, a random access memory (RAM) for temporary storing of information, and/or a read-only memory (ROM) for permanently storing information. The storage device 102 can also be an external storage system, such as a hard disk, a storage card, or a data storage medium. In at least one embodiment, the storage device 102 can include two or more storage devices such that one storage device is a memory and the other storage device is a hard drive. Additionally, one or more of the storage devices 102 can be located externally relative to the electronic device 100.

The equation computing system 200 running in the electronic device 100 is stored in the storage device 102. The equation computing system 200 can include a number of modules, which are collection of software instructions executed by the processor 101.

In at least one embodiment, the equation computing system 200 can include an input receiving module 10, a vector conversion module 11, a non-linear equation obtaining module 12, a curve surface fitting module 13, and an equation computing module 14.

The input receiving module 10 can receive parameters and a conversion equation for converting the parameters to vectors input by the user via the input device 103. In least one embodiment, the parameters are space coordinates of a number of pixels of an image to be processed, for example, the parameters are X, Y, Z coordinates of a number of pixels of an image. In the embodiment, the conversion equation can be a function named as “meshgrid” of the MATLAB software.

The vector conversion module 11 is configured to convert the parameters input by the user into vectors according to the conversion equation.

The non-linear equation obtaining module 12 is configured to obtain a non-linear equation according to the vectors obtained by the vector conversion module 11. In at least one embodiment, the non-linear equation obtaining module can obtain the non-linear equation according to the vectors by invoking a “lsqcurvefit” function of the MATLAB software.

The curve surface fitting module 13 is configured to execute a curve surface fitting process to obtain a fitting curve surface according to the non-linear equation. In at least one embodiment, the curve surface fitting module 13 uses a Gauss-Newton algorithm to obtain the fitting curve surface according to the non-linear equation.

The equation computing module 14 is configured to obtain a fitting equation according to the fitting curve surface obtained by the curve surface fitting module 13. In at least one embodiment, the equation computing module 14 obtains the fitting equation by using the MATLAB software, such as by invoking programs of the MATLAB software. In at least one embodiment, the fitting equation obtained by the equation computing module 14 is: y=b(1)*x1+b(2)*x2+b(3)*x1.\hat{2}+b(4)*x2.\hat{2}+b(5)*x1.*x2+b(6) *x1.\hat{3}+b(7)*x2.\hat{3})./(1+b(8) *exp(b(9)*x1+b(10)*x2+b(11)*x1.*x2)), wherein x1=X, x2=Y, y: Z, X, Y, Z are space coordinates of one of the pixel of the image to be processed, and initial value of b is [0.07, 0.07, −0.12, −0.12, −0.13, −0.003, −0.003, −0.98, 0.03, 0.03, −0.0006].

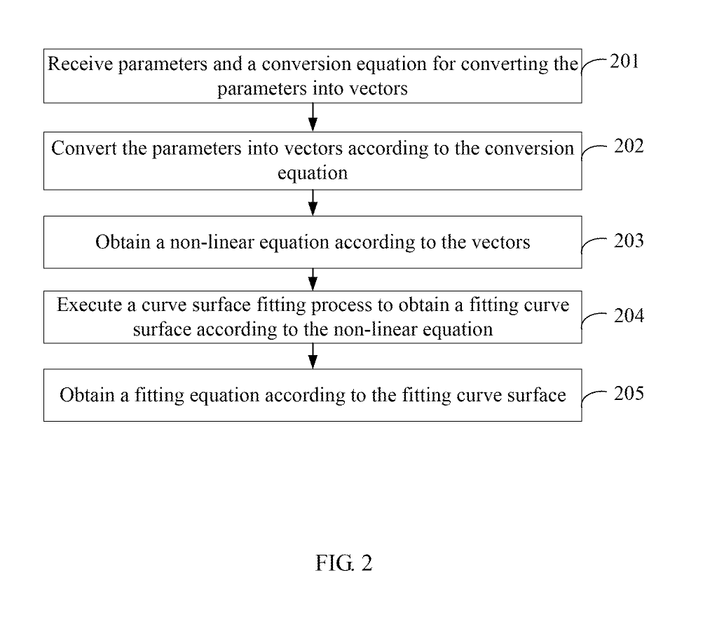

FIG. 2 illustrates an embodiment of an equation computing method. The method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Additionally, the illustrated order of blocks is by example only and the order of the blocks can be changed. The example method can begin at block 201.

At block 201, an input receiving module receives parameters and a conversion equation for converting the parameters into vectors input by a user. In at least one embodiment, the parameters are space coordinates of a number of pixels of an image to be processed, for example, X, Y, Z coordinates of a number of pixels of an image. In the embodiment, the conversion equation can be a function named as “meshgrid” of the MATLAB software.

At block 202, an vector conversion module converts the parameters input by the user into vectors according to the conversion equation.

At block 203, an non-liner equation obtaining module obtains a non-linear equation according to the vectors obtained by the vector conversion module.

At block 204, a curve surface fitting module executes a curve surface fitting process to obtain a fitting curve surface according to the non-linear equation.

At block 205, an equation computing module obtains a fitting equation according to the fitting curve surface obtained by the curve surface fitting module.

To easily understand the present disclosure, an example program codes of the functions, such as the “meshgrid” and the “lsqcurvefit” invoked by the modules of the equation computing system 200 are provided as below, the program codes are programmed in MATLAB programming language:

%main program
clear, clc
[x, y] = meshgrid(0:13, 0:19);
z=[0.00 4.76 9.50 14.06 18.50 23.36 28.10 32.89 37.57 42.10 46.88 51.72
56.59 61.03;

4.72 6.52 10.41 14.63 19.02 23.60 28.40 33.03 37.74 42.19 46.96

51.72 56.51 61.05;

9.16 10.46 13.19 16.81 20.75 25.08 29.62 34.18 38.70 43.13 47.81

52.55 57.34 61.69;

13.79 14.57 16.77 19.73 23.16 27.15 31.33 35.75 40.03 44.43 48.95

53.60 58.21 62.56;

18.47 19.10 20.79 23.14 26.44 29.81 33.81 37.83 41.91 46.12 50.46

54.94 59.55 63.83;

23.04 23.61 24.87 27.04 29.73 32.99 36.57 40.43 44.24 48.20 52.43

56.77 61.23 65.43;

27.83 28.26 29.37 31.31 33.59 36.44 39.84 43.40 47.01 50.73 54.63

58.94 63.29 67.26;

32.62 32.86 33.83 35.52 37.61 40.14 43.27 46.42 49.90 53.41 57.32

61.36 65.43 69.39;

37.11 37.42 38.30 39.85 41.76 43.87 46.79 49.89 53.15 56.33 60.02

63.94 67.90 71.63;

41.99 42.19 42.89 44.40 46.01 48.01 50.74 53.51 56.65 59.56 63.09

66.87 70.70 74.38;

46.70 46.82 47.44 48.87 50.22 52.18 54.59 57.20 60.03 62.98 66.25

69.83 73.52 77.14;

51.34 51.40 52.13 53.37 54.76 56.44 58.70 61.19 63.95 66.63 69.67

73.08 76.76 80.20;

55.95 56.13 56.77 57.94 59.14 60.61 62.79 65.14 67.58 70.20 73.21

76.45 79.87 83.15;

60.61 60.66 61.35 62.34 63.46 65.04 67.00 69.12 71.59 73.94 76.77

79.95 83.17 86.44;

65.20 65.47 66.12 67.07 68.06 69.37 71.28 73.41 75.61 77.87 80.55

83.62 86.79 89.87;

69.78 69.95 70.50 71.54 72.48 73.78 75.47 77.50 79.56 81.88 84.44

87.22 90.35 93.35;

74.52 74.75 75.24 76.26 77.18 78.33 80.03 81.83 83.85 85.97 88.54

91.22 94.06 96.91;

79.28 79.38 79.81 80.90 81.79 82.86 84.53 86.13 88.12 90.17 92.46

95.10 97.86 100.57;

83.78 84.07 84.53 85.41 86.08 87.17 88.89 90.50 92.25 94.17 96.46

99.04 101.71 104.29;

88.41 88.64 89.04 89.93 90.74 91.74 93.27 94.76 96.53 98.38 100.51

103.10 105.57 108.10];
x=x(:);y=y(:);z=z(:);
X=[x,y];
b=[0.07,0.07,−0.12,−0.12,−0.13,−0.003,−0.003,−0.98,0.03,0.03,−0.0006]; % initial value of b
[x1,y1]=meshgrid(0:.25:13,0:.25:19); %converting the parameters to vectors
% folowing is the fitting process
for 1=1:10

b=lsqcurvefit(‘fx2’,b,X,z) %obtaining a non-linear equation
b=nlinfit(X,z,‘fx2’,b) % do a curve surface fitting process
figure(1),clf
plot3(x,y,z,‘o’)
stem3(x,y,z,‘filled’)
z1=fx(b,x1,y1);

```
  hold on
  surf(x1,y1,z1)%curve surface
  shading interp
  alpha(.8)
  pause(.5)
end
% self-defined function 1
```

function yhat=fx(b,x1,x2)
yhat=(b(1)*x1+b(2)*x2+b(3)*x1.\hat{ }2+b(4)*x2.\hat{ }2+b(5)*x1.*x2+b(6)*x1.\hat{ }3+b(7)*x2.\hat{ }3)./(

1+b(8)*exp(b(9)*x1+b(10)*x2+b(11)*x1.*x2));

The embodiments shown and described above are only examples. Many further details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device comprising:
an input device;
a storage device;
a processor coupled to the storage device and the input device;
an input receiving module, stored in the storage device, comprising instructions to cause the processor to receive parameters and a conversion equation for converting the parameters to vectors via the input device;
a vector conversion module, stored in the storage device, comprising instruction to cause the processor to convert the parameters input by the user to vectors according to the conversion equation, thus to obtain the vectors;
a non-linear equation obtaining module, stored in the storage device, comprising instruction to cause the processor to obtain a non-linear equation according to the obtained vectors;
a curve surface fitting module, stored in the storage device, comprising instruction to cause the processor to execute a curve surface fitting process to obtain a fitting curve surface according to the non-linear equation; and
an equation computing module, stored in the storage device, comprising instruction to cause the processor to obtain a fitting equation according to the fitting curve surface obtained by the curve surface fitting module.

2. The electronic device of claim 1, wherein the parameters inputted by the user are space coordinates of a number of pixels of an image to be processed.

3. The electronic device of claim 1, wherein the curve surface fitting module cause the processor to execute the curve surface fitting process by using a Gauss-Newton algorithm.

4. The electronic device of claim 1, wherein the fitting equation computed by the processor is:
y=b(1)*x1+b(2)*x2+b(3)*x1.\hat{2}+b(4)*x2.\hat{2}+b(5)*x1.*x2+b(6) *x1.\hat{3}+b(7)*x2.\hat{3})./(1+b(8) *exp(b(9)*x1+b(10)*x2+b(11)*x1.*x2)), wherein x1=X, x2=Y, y: Z, X, Y, Z are space coordinates of one of the pixel of the image to be processed, and initial value of b is [0.07, 0.07, −0.12, −0.12, −0.13, −0.003, −0.003, −0.98, 0.03, 0.03, −0.0006].

5. An equation computing method applied in an electronic device, the electronic device comprising a processor, the method comprising:
receiving parameters and a conversion equation for converting the parameters into vectors input by a user by the processor;
converting the parameters input by the user to vectors according to the conversion equation by the processor, thus to obtain the vectors;
obtaining a non-linear equation according to the obtained vectors by the processor;
executing a curve surface fitting process by the processor to obtain a fitting curve surface according to the non-linear equation; and
obtaining a fitting equation by the processor according to the fitting curve surface.

6. The equation computing method of claim 5, wherein the parameters input by the user are space coordinates of a number of pixels of an image to be processed.

7. The equation computing method of claim 6, wherein the method for executing the curve surface fitting process by using a Gauss-Newton algorithm.

8. The equation computing method of claim 7, wherein the fitting equation computed by the processor is:
y=b(1)*x1+b(2)*x2+b(3)*x1.\hat{2}+b(4)*x2.\hat{2}+b(5)*x1.*x2+b(6) *x1.\hat{3}+b(7)*x2.\hat{3})./(1+b(8) *exp(b(9)*x1+b(10)*x2+b(11)*x1.*x2)), wherein x1=X, x2=Y, y: Z, X, Y, Z are space coordinates of one of the pixel of the image to be processed, and initial value of b is [0.07, 0.07, −0.12, −0.12, −0.13, −0.003, −0.003, −0.98, 0.03, 0.03, −0.0006].
